(19) United States
(12) Patent Application Publication
(10) Pub. No.: US 2025/0182591 A1
(43) Pub. Date: Jun. 5, 2025

(54) Claw Cutter Combination Amusement Machine

(71) Applicant: Brian Keith Riggles, St. Louis, MO (US)

(72) Inventor: Brian Keith Riggles, St. Louis, MO (US)

(21) Appl. No.: 18/965,765

(22) Filed: Dec. 2, 2024

Related U.S. Application Data
(60) Provisional application No. 63/604,750, filed on Nov. 30, 2023.

(51) Int. Cl. G07F 17/32

(52) U.S. Cl. CPC G07F 17/3295; G07F 17/3209; G07F 17/3216; G07F 17/3248; G07F 17/3253; G07F 17/3255; G07F 17/3297

(57) ABSTRACT

A coin-operated amusement machine integrating three distinct skill-based games: a cutter game, a carousel poke game, and a crane game, housed within a single cabinet. The cutter game involves precise alignment and activation of a cutting mechanism to release a prize suspended by a rope. The carousel poke game challenges players to stop a rotating platform and engage a poking mechanism to release a prize. The crane game features a joystick-controlled claw for retrieving prizes, with configurations for standard or “win every time” gameplay. The cabinet incorporates multicolor LED lighting for enhanced visual engagement, along with modular controls, prize dispensing systems, and operator-configurable settings for payouts and gameplay difficulty. Constructed from durable materials, the machine provides a versatile and engaging experience, appealing to a broad audience. This invention combines multiple gaming formats into a unified, customizable unit, ideal for arcades and entertainment venues.

### FEDERALLY SPONSORED RESEARCH

Not Applicable

### SEQUENCE LISTING OR PROGRAM

Not Applicable

### TECHNICAL FIELD OF THE INVENTION

The present invention relates generally to an amusement machine. More specifically, the present invention relates to an amusement machine which accommodates the playing means for three different games of skill that can be played individually or in combination.

### BACKGROUND OF THE INVENTION

A claw crane (also called a variety of other names) is a type of arcade game known as a merchandiser, commonly found in video arcades, supermarkets, restaurants, movie theaters, and bowling alleys. A claw crane may also be referred to as a teddy picker, candy crane, claw machine, crane vending machine, arcade claw, grab machine, crane game or simply the claw.

A claw crane consists of many parts, but the basic components are a PCB, power supply, currency detector, credit/timer display, joystick, wiring harness, bridge assembly, and claw. The claw will have two or more prongs or arms, although most claws will usually have three.

The cabinet is usually constructed of medium-density fiberboard (MDF), plywood or other wood or plastic materials. Some cabinets are made of aluminum alloy or other metals such as 18 gauge steel, which makes it easier to relocate as well as cheaper to produce. The window at the front of the machine is normally made of glass or a cheaper-to-manufacture substitute, such as acrylic. The marquee is a branded graphic sometimes created specifically for restaurants or an operator's business name behind the front.

A claw vending machine consists of prizes, usually plush toys or alternatives such as jewelry, capsulated toys, hats, balls, dolls, shirts, candy and electronics. Higher end and more expensive prizes are sometimes placed in a plastic bag so the toy is harder to pick up. The player places coins into the machine, which then allows the player to manipulate a joystick that controls the claw for a variable time (controlled by the operator) usually 15 to 30 seconds (in some cases, a claw vending machine might offer a minute of time). The player is able to move the claw back, forth and sideways, although some machines allow the player to move the claw after it has partially descended.

At the end of the play time (or earlier if the player presses a trigger button on the joystick), the claw descends down and makes an attempt to grip. After making the gripping attempt, the claw then moves over an opening in the corner of the case and releases its contents. If the player is successful, then the prize the claw is holding is dropped into the opening and dispensed through a chute into a hatch for collection.

In alternative versions of claw machines, the cabinet is used to enable the game play of one or more additional games, providing more game play options to a player.

Therefore what is needed is a new and useful combination of game machines to make the gameplay more fun and enticing for players.

### SUMMARY OF THE INVENTION

The present invention is a coin-operated amusement machine combining multiple games of skill within a single game cabinet. The cabinet accommodates three distinct games: a “cut-the-rope” cutter game, a carousel poke game, and a crane game. These games can be played individually or sequentially, with flexible gameplay configurations and operator-controlled prize adjustments.

The cutter game challenges players to release a prize by cutting a rope using a joystick-controlled cutter mechanism. Precision and timing are critical as players align the cutter above the rope and press an action button to sever it, releasing the prize into a chute or opening a hinged prize door.

The carousel poke game features a rotating platform displaying multiple prizes. Players use a joystick to align a poking mechanism with a prize's securing mechanism. Once aligned, pressing a button stops the carousel, activates the poking mechanism, and, if successful, releases the prize into a collection chute. The dynamic movement of the carousel adds an element of skill and strategy.

The crane game includes a traditional claw mechanism where players use a joystick to maneuver the claw above a desired prize. Pressing a button lowers the claw to attempt to grab the prize, which is then deposited into a prize chute if successfully retrieved. The crane game can be configured as a “win every time” game or with standard payout settings.

The cabinet is constructed from durable materials such as MDF, aluminum alloy, or plastic and incorporates advanced features like multicolor LED lighting to enhance visual appeal. Each game includes its own control interface, coin or bill acceptor, and prize dispensing system. Operators can configure prize availability, payout rates, and gameplay difficulty to meet business requirements.

This innovative design integrates three popular arcade games into a single unit, providing varied gameplay experiences and increased entertainment value for users. The invention's modular design and customizable settings ensure broad applicability in arcades, entertainment venues, and retail spaces.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a perspective view of an amusement machine illustrating the crane machine and the marquee of the crane machine cabinet containing the games of chance and win every time games according to the present invention.

FIG. 2 is a perspective view of an amusement machine illustrating the crane machine in combination with a cutter game and a carousel game.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the present invention is a game machine cabinet comprising a housing with a number of upright walls, said housing being adapted to accommodate the playing means for three different games of skill that can be played individually or in combination, for instance pick-up means such as a grabber and a separate game with a cutter which cuts a string to release a prize; wherein the upright walls of the housing comprise at least one translucent panel and a pattern of multicolor LED lights being connected to a control unit for the controlling the color being emitted by each multicolor light.

The cabinet may be utilized as a third game comprising an apparatus for playing a win every time game; the apparatus comprising a button to stop the moving flashing LED lights located on the corners of the cabinet and along the top and bottom of the cabinet to win a prize dispensed by a thermal printer; a specific or random prize coupon depending on the location of the flashing lights when the button is pressed to stop the moving, flashing light.

In the first embodiment, the game cabinet includes two games of skill plus a light game. The game cabinet is comprised of a housing, 2 user access panels with controllers, a housing with upright walls, a playfield surface that may include a rotating field, a control unit to control each multicolor LED light, at least one translucent panel, a 2 object retrieving area; and an outlet, door or hatch or printer to receive one or more prizes.

In a second embodiment, the present invention is a game machine wherein the controller is a joystick that controls a retriever that is moveable along a track that is supported by the housing with an integrated activation button.

In a third embodiment, the present invention is a game machine wherein a prize is suspended by a string and a cutter that is moveable along a track that is supported by the housing with an integrated activation button.

In a fourth embodiment the present invention is a game that utilizes multicolor LED lights and at least one translucent panel with an integrated activation button to issue a prize coupon.

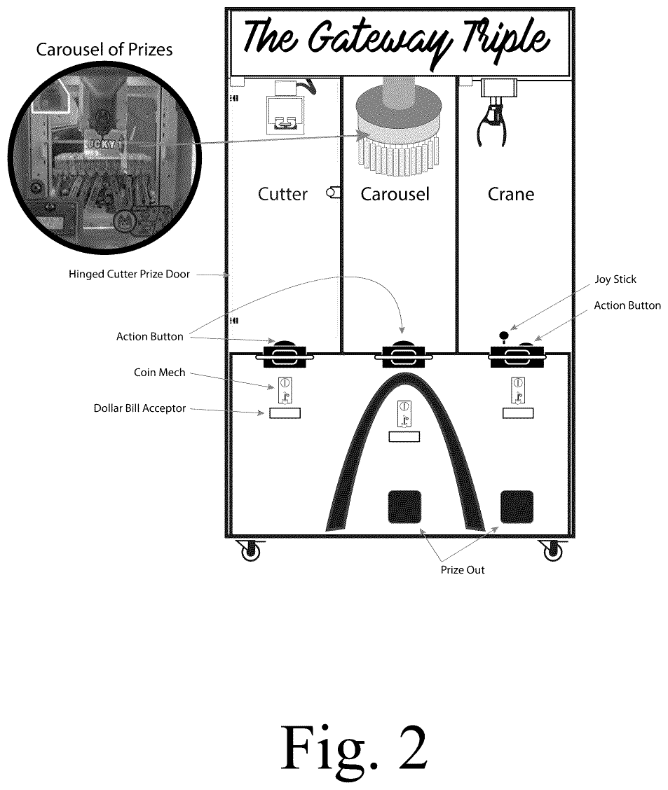

FIG. 2 is a perspective view of an amusement machine illustrating the crane machine in combination with a cutter game and a carousel poke game.

In this alternative embodiment shown in FIG. 2, the machine is a triple play machine comprising a cutter game, a carousel poke game, and a crane game. In this embodiment, the three games can be placed in any order of play, appearance, or sequence/layout in the game machine cabinet.

In the exemplary embodiment shown in FIG. 2, the first game is a typical cut-the-rope or cutter game which takes up generally a third of the gaming cabinet. The cutter game has a hinged cutter prize door on one external panel of the game machine cabinet. A coin mech and dollar bill acceptor to take money in exchange for game play credits and an action button is located on the front face of the game machine for initiating game play.

A “cut the rope” or “cutter” game is a skill-based arcade game where players aim to release a prize by precisely cutting a rope that suspends it. The game begins with the player inserting a coin or token to activate the mechanism. Using a joystick or control, the player maneuvers a cutting tool along a track to position it directly above the rope. Once aligned, the player presses a button to activate the cutter, which attempts to sever the rope cleanly. The challenge lies in timing and accuracy, as the player must ensure the cutter is perfectly positioned for a successful cut. If the rope is cut correctly, the prize drops into a collection chute or hatch for retrieval or a hinged cutter prize door is opened. The game resets after each attempt, presenting a new challenge for the next player. Its straightforward yet engaging mechanics make “Cut the Rope” a popular choice in arcades and entertainment venues.

In the exemplary embodiment shown in FIG. 2, a carousel poke game takes up approximately a third of the middle section of the game machine cabinet. The carousel poke game includes a coin mech and dollar bill acceptor to take money in exchange for game play credits and an action button is located on the front face of the game machine for initiating game play along with a prize cute for delivering a won prize.

The carousel game machine offers an engaging gameplay experience centered around a rotating platform that showcases multiple prizes. Players begin by inserting a coin or token to activate the machine, causing the carousel to spin and display an array of enticing rewards. Using a joystick or control system, players must skillfully position a retrieval mechanism, such as pin to poke or engage the secure/release mechanism over a prize on the rotating carousel game field, over their desired prize. Timing and precision are essential, as the continuous rotation of the platform adds an extra layer of challenge. Once the player is confident in their aim, they press a button to activate the mechanism, which attempts to poke the prize or and release the mechanism holding/suspending it. If successful, the prize is deposited into a collection chute or hatch for retrieval. Some versions of the game may also feature bonus rounds or secondary games for additional rewards. After each attempt, the carousel resets its rotation and prizes, ready for the next player. This combination of dynamic movement, skill-based interaction, and visual appeal makes the carousel game a popular attraction in arcades and amusement venues.

In the exemplary embodiment shown in FIG. 2, a crane game takes up approximately a third of the right section of the game machine cabinet. The claw game includes a coin mech and dollar bill acceptor to take money in exchange for game play credits and an action button is located on the front face of the game machine for initiating game play along with a prize cute for delivering a won prize.

A crane machine game is a classic arcade attraction where players aim to retrieve prizes using a mechanical claw. The game starts when a player inserts a coin or token, activating the machine and granting control of the claw via a joystick or directional buttons. The player maneuvers the claw above their desired prize, carefully aligning its position. Once satisfied, the player presses a button to lower the claw, which attempts to grab the prize. Success depends on the claw's grip strength, alignment, and the prize's size or weight. If successful, the claw carries the prize to a collection chute, where it is released for retrieval. The machine resets after each attempt, ready for the next round. The combination of skill, timing, and chance makes the crane machine a timeless favorite in arcades and entertainment venues.

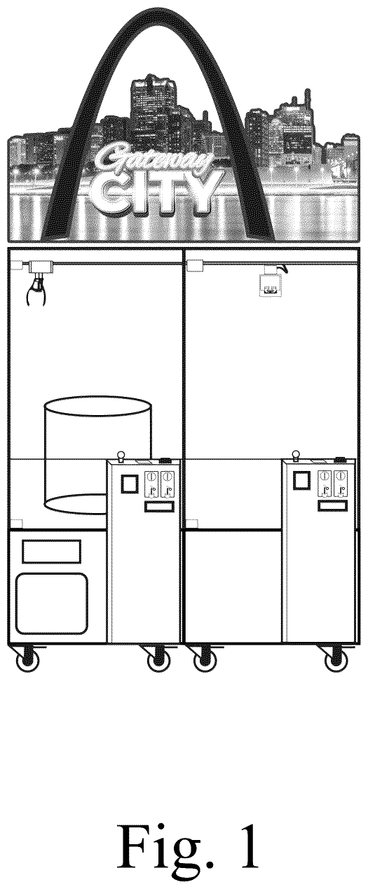

Referring to FIG. 2, the present invention is a coin operated amusement device that is comprised of a cut-the-rope or cutter game, a carousel or marquee light game, and a crane game in combination as shown in FIGS. 1 and 2. When a player deposits their coins or inserts their bills, they are able to play one, two, or three games. One game is a cut the rope or cutter game. A second game, is a carousel poke game which requires a player to press a button to stop a moving carousel, when they believe the desired prize and poking mechanism are in alignment such that upon pressing a button the carousel stops, the poke mechanism extends and if in alignment the poking mechanism engages the prize secure/holding mechanism and releases the prize into the price chute or results in a win and credits or tickets.

Finally, in the third game, the player plays a standard claw machine crane game. If the player wins the crane game, the prize may be products or tickets that can be redeemed via an online website/store or even additional crane free plays.

The basic components of the cut the rope or cutter game are a cabinet as shown in the figures, a rope and cutter mechanism mounted inside the cabinet, and motorized means for maneuvering the cutter to cut the rope, which may result in a prize win as shown in the Figures and discharge them through an outlet or prize door, a PCB, power supply accessed through a board access panel, currency detector, credit/timer display, joystick, wiring harness, bridge assembly, button, claw, and coin door for retrieving deposited money or coins by the operator.

The basic components of the carousel poke game are a cabinet as shown in the figures, a carousel mechanism mounted inside the cabinet, and motorized means for poking or engaging the prize holding mechanisms of the individual prizes secured to the rotating carousel, which may result in a prize win if the poking mechanism is aligned with the secure or prize holding mechanism when the button is pressed as shown in the Figures and discharges a won prize through an outlet or prize door, a PCB, power supply accessed through a board access panel, currency detector, credit/timer display, joystick, wiring harness, bridge assembly, button, claw, and coin door for retrieving deposited money or coins by the operator.

The basic components of the claw game are a cabinet as shown in the figures, a crane mechanism mounted inside the cabinet, and motorized means for maneuvering the crane to pick up prizes as shown in the Figures and discharge them through an outlet or prize door, a PCB, power supply accessed through a board access panel, currency detector, credit/timer display, joystick, wiring harness, bridge assembly, button, claw, and coin door for retrieving deposited money or coins by the operator.

Not all components are shown or illustrated in the drawings as they are well known in the art and not necessary for one of ordinary skill in the art to make or use the present invention. Drawings of these elements are unnecessary for the understanding of the subject matter to be patented.

The cabinet, as shown in the figures is usually constructed of medium-density fiberboard (MDF), aluminum alloy, plastic or any other wood, metal or composite material. The windows at the front of the machine are made of glass or acrylic. The marquee is a branded graphic created specifically for the cutter game and crane game, game of chance, and is located behind or on the front panel window of the cabinet.

The player places coins into the machine's coin slots or bill acceptor, which then allows the player to manipulate a joystick or one or more buttons that controls the claw for a variable time, controlled by the operator. The player is able to move the claw back, forth and sideways. At the end of the play time or earlier if the player presses a trigger button, the claw descends or drops down and makes an attempt to grip. After making the gripping attempt, the claw then moves over an opening in the corner of the case and releases its contents as shown in the figures. If the player is successful, then the prize the claw is holding is dropped into the opening and dispensed through a chute into a hatch for collection. In a conventional crane machine game, the player will have an allotted period of play time before the crane becomes inoperable. In a win every time crane game, the player can continue to maneuver the claw until a prize is detected in the dispensing chute opening by detection means.

Upon ending play on the first game, the player starts play on a second game, which is a game of chance. The second game, is a carousel poke game which requires a player to press a button to stop a moving carousel, when they believe the desired prize and poking mechanism are in alignment such that upon pressing a button the carousel stops, the poke mechanism extends and if in alignment the poking mechanism engages the prize secure/holding mechanism and releases the prize into the price chute or results in a win and credits or tickets.

Upon ending play on the second game, the player starts play on a third and final game. In the third game, the player plays a standard claw machine crane game. If the player wins the crane game, the prize may be products or tickets that can be redeemed via an online website/store or even additional crane free plays.

The games may be played in any order or in any combination or order of game play. The prizes and payout may also be adjusted as desired by the operator. The game play of each game may also be adjusted by the operator to control winning percentages and payouts.

In alternative embodiment, the crane machine may be win every time or traditional crane machines or replaced with any arcade machine or possibly a juke box in any combination with one or more of the games of chance described above.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to

the design are anticipated. Thus, the scope of the invention should be determined by the appended claims and their legal equivalents, rather than by the examples given.

The embodiments of the invention in which an exclusive property or privilege is claimed are defined as follows:

1. A housing configured to accommodate multiple games of skill;
a cutter game including a cutting mechanism operable by a player to sever a rope suspending a prize;
a carousel poke game featuring a rotating platform, a prize securing mechanism, and a poking mechanism operable by a player to release a prize;
a crane game with a claw mechanism operable by a player to retrieve a prize; and
a prize dispensing system for each game.

2. The amusement machine of claim 1, wherein the cutter mechanism includes a joystick for alignment and an activation button for cutting.

3. The amusement machine of claim 1, wherein the carousel poke game further comprises:
a joystick to position the poking mechanism; and
a button to stop the carousel and activate the poking mechanism.

4. The amusement machine of claim 1, wherein the crane game includes:
a joystick for controlling the claw's movement; and
a button to lower the claw to attempt prize retrieval.

5. The amusement machine of claim 1, wherein the housing includes translucent panels with multicolor LED lighting controlled by a programmable system for dynamic visual effects.

6. The amusement machine of claim 1, further comprising a coin or bill acceptor operable to activate any of the games upon receiving payment.

7. The amusement machine of claim 1, wherein the cutter game includes a hinged prize door that opens upon successful severing of the rope.

8. The amusement machine of claim 1, wherein the carousel poke game includes a dynamic prize alignment mechanism for varying difficulty levels.

9. The amusement machine of claim 1, wherein the crane game is configurable for standard or “win every time” gameplay modes.

10. The amusement machine of claim 1, further comprising a control panel for the operator to adjust prize availability, game difficulty, and payout percentages.

11. The amusement machine of claim 1, wherein prizes include physical items, tickets, or coupons redeemable online or at the location.

12. The amusement machine of claim 1, wherein the rotating platform of the carousel poke game includes a motorized drive system with adjustable speed settings.

13. The amusement machine of claim 1, further comprising a thermal printer for dispensing prize coupons or tickets.

14. The amusement machine of claim 1, wherein the LED lighting system synchronizes with gameplay events to enhance player engagement.

15. The amusement machine of claim 1, wherein the housing is modular, allowing for reconfiguration or replacement of individual game components.

16. A game machine cabinet, comprising:
a housing with a plurality of upright walls, including at least one translucent panel;
means for playing three distinct games of skill individually or in combination, including:
a pick-up mechanism;
a cutter mechanism for releasing a prize suspended by a string;
a win-every-time game with a button to halt moving flashing LED lights to win a prize;
multicolor LED lights connected to a control unit for regulating emitted colors; and
a prize dispensing system that issues a specific or random prize based on gameplay outcomes.

17. The game machine cabinet of claim 16, wherein the win-every-time game dispenses a prize coupon or ticket through a thermal printer based on the location of the flashing LED lights when the button is pressed.

18. The game machine cabinet of claim 16, further comprising:
a joystick-based controller for maneuvering a retriever along a track; and
an integrated activation button for gameplay.

19. The game machine cabinet of claim 16, wherein the housing accommodates a playfield with a rotating surface, two user access panels, and multiple prize retrieval areas with outlets, doors, or hatches for prize collection.

20. The game machine cabinet of claim 16, wherein the games are configured to allow operator adjustments to prize availability, game difficulty, and payout rates to suit varied player experiences.
